(19) United States
(12) Patent Application Publication
(10) Pub. No.: US 2013/0330520 A1
(43) Pub. Date: Dec. 12, 2013

(54) HEARTH ROLL HAVING EXCELLENT MN BUILD-UP RESISTANCE, THERMAL SHOCK RESISTANCE, AND ABRASION RESISTANCE, AND THERMAL SPRAY MATERIAL THEREFOR

(71) Applicant: Nippon Steel Hardfacing Co., Ltd., Tokyo (JP)

(72) Inventors: Tatsuhiro SHIGEMITSU, Tokyo (JP); Junichi YASUOKA, Tokyo (JP)

(73) Assignee: Nippon Steel Hardfacing Co., Ltd., Tokyo (JP)

(21) Appl. No.: 13/966,448

(22) Filed: Aug. 14, 2013

Related U.S. Application Data
(62) Division of application No. 12/937,635, filed on Dec. 13, 2010.

(30) Foreign Application Priority Data
Jun. 10, 2008 (JP) 2008-152045

(51) Int. Cl. F27B 9/24

(52) U.S. Cl. CPC F27B 9/2407
USPC 428/174

(57) ABSTRACT

A long-life hearth roll having excellent build-up resistance against Mn-based substances, and which has excellent thermal shock resistance and abrasion resistance is provided. The thermal spray material that is thermally sprayed onto a surface of the hearth roll is characterized by including a heat resistant metal (including an alloy) that includes Al and can be used at 900° C. or more, and a complex oxide of one kind or two kinds or more of a rare earth element (Sc, Y, lanthanum, and lanthanoids) and a transition metal excluding group 3A of the periodic table, Zr, Hf, and Fe, wherein when an Al content is A (moles), and a rare earth element (Sc, Y, lanthanum, and lanthanoids) content is B (moles), the thermal spray material satisfies a condition of 0.3≦(A/B)≦4.0.

### TECHNICAL FIELD

The present invention relates to a hearth roll for conveying a steel sheet arranged in a continuous heat treatment furnace, and a thermal spray material therefor. In particular, the present invention relates to a hearth roll having excellent Mn build-up resistance, thermal shock resistance, and abrasion resistance, and a thermal spray material therefor.

### BACKGROUND ART

A hearth roll arranged in a steel sheet heat treatment furnace is used for long periods in a weakly oxidizing or reducing atmosphere at 600 to 1300° C. Consequently, the surface of a hearth roll is required to have the following main characteristics.

1) Fe oxides and iron powder are adhered to the steel sheet. During conveyance of the steel sheet, these Fe oxides and iron powder stick to and are deposited on the surface of the hearth roll, thereby forming “build-up”. Further, recently, due to an increase in high-tensile steel and other changes in the furnace operation conditions, Mn oxide build-up has become a problem. Therefore, the hearth roll needs to have build-up resistance against Fe- and Mn-based substances.
2) Regions having different temperatures are provided in the interior of a continuous furnace. The temperature of a steel sheet conveyed through a continuous furnace changes due to these temperature regions. Therefore, the hearth roll, which is in contact with the steel sheet, needs to have thermal shock resistance against peeling and cracking produced due to temperature changes.
3) The hearth roll is slidably abraded due to the steel sheet coming into contact with the hearth roll during conveyance. Thus, the hearth roll needs to have abrasion resistance.

If these characteristics are insufficient, a coating on the surface of the hearth roll can peel due to sliding abrasion, build-up, and thermal shock. In addition, when a steel sheet contacts a hearth roll from which the coating has peeled, flaws are produced on the surface of the steel sheet, which becomes a factor in quality deterioration.

Examples of conventional technologies for preventing a coating on a hearth roll surface from peeling include the following disclosed methods. Patent Document 1 discloses a roll for a heat treatment furnace having excellent build-up resistance and abrasion resistance, which has a ceramic coating formed from a Ti nitride or a Ti carbide. Ti nitrides and Ti carbides have excellent abrasion resistance and build-up resistance.

Patent Document 3 discloses a hearth roll having a surface coating layer formed from two layers, a surface layer and a bonding metal layer which acts as a surface layer base. The surface layer has a microstructure in which TiN particles coated with a metal oxide layer (excluding iron oxides) that is stable at 1,400° C. are dispersed in a metal (excluding iron and iron alloy) matrix formed from a 900° C. heat-resistant metal. The abrasion resistance and thermal shock resistance of the coating improve due to the coating forming a cermet and the provision of the bonding layer between the coating and the roll matrix. In addition, build-up resistance is also expected to improve due to the TiN being coated with a metal, thereby preventing oxidation of the TiN during thermal spraying, and the hearth roll having an abradable quality due to the coated metal turning into an oxide.

Patent Document 2 discloses a hearth roll having a thermal spray coating formed from a cermet thermal spray material which is formed from a mixture of 5 to 90% by weight of an oxide that has low manganese oxide reactivity in a heat resistant alloy with a general formula of MCrAlY (wherein M is at least one metal element selected from the group consisting of Fe, Ni, and Co), in which the Al content is 10 at. % or less and the (Al+Cr) content is 13 at. % or more to 31 at. % or less.

Patent Document 4 discloses a hearth roll surface coating material, which is a composite material in which 5 to 80 mass % of one kind or a plurality of kinds of ceramics selected from oxide ceramics, carbide ceramics, and boride ceramics is dispersed in an alloy formed from 5 to 35 mass % of Cr, 3 mass % or less of C, and 3 to 40 mass % in total of one kind or two or more kinds selected from 3 to 25 mass % of Ni, 3 to 25 mass % of W, and 3 to 25 mass % of Ta, with a balance of Co and unavoidable impurities, characterized in that an Al component in the composite material is 1 mass % or less in terms of Al.

Patent Document 5 discloses a thermal spray powder for a furnace interior roll formed from a mixture of an alloy powder and a ceramic powder, which is sprayed onto the roll surface to form a coating, wherein the alloy powder is formed from 3 to 8 mass % of Al based on the total amount of the alloy powder and a balance of one kind or more selected from Co and Ni and is contained in an amount of 40 to 80 mass % of the alloy powder based on the total amount of the thermal spray powder, and wherein the ceramic powder is formed from 10 to 30 mass % of Y₂O₃ and Cr₂O₃ based on the total amount of the thermal spray powder.
[Patent Document 1] Japanese Patent Application Laid-Open No. Sho 63-250449
[Patent Document 2] Japanese Patent Application Laid-Open No. Hei 8-67960
[Patent Document 3] Japanese Patent Application Laid-Open No. Hei 10-195547
[Patent Document 4] Japanese Patent Application Laid-Open No. 2002-256363
[Patent Document 5] Japanese Patent Application Laid-Open No. 2003-27204

### DISCLOSURE OF THE INVENTION

### Problems to be Solved by the Invention

Conventionally, although the main component of build-up was Fe, recently, due to an increase in high-tensile steel and other changes in the furnace operation conditions, the main component of build-up has changed from Fe to Mn.

However, for the configuration disclosed in Patent Document 1, the thermal spray coating formed from a Ti nitride or a Ti carbide is susceptible to oxidation during thermal spraying, and has many pores and is thus very brittle. Consequently, the thermal spray coating can peel from the roll surface due to sliding abrasion when conveying the steel sheet. Therefore, it is difficult to use the hearth roll for a long duration.

Furthermore, for the configuration disclosed in Patent Document 3, oxidation of the TiN during thermal spraying cannot be sufficiently prevented, and the flight time of the thermal spray material is too short (in the order of several msec). Consequently, the coated metal is hardly oxidized, and the build-up resistance cannot be said to be sufficient. In addition, the TiN particles need to be coated with a metal using a method such as plating, PVD, CVD, and mechanical alloying, which causes costs to increase. Therefore, there is a problem in terms of economic efficiency.

In addition, for the configuration disclosed in Patent Document 2, if the ratio of the MCrAlY is large, although thermal shock resistance and abrasion resistance improve, sufficient build-up resistance cannot be obtained due to the Al and Cr content being limited. Further, if the ratio of the ceramic is large, the thermal shock resistance and abrasion resistance are insufficient.

Moreover, for the configuration disclosed in Patent Document 4, due to Al approaching 0%, although build-up caused by Al can be prevented, the oxidation resistance of the coating is poor. Consequently, sufficient effects cannot be exhibited, so that, for example, the abrasion rate can increase.

Still further, for the configuration disclosed in Patent Document 5, to compensate for the drawbacks in Patent Document 4, the Al in the matrix is decreased from Patent Document 2 and set at 3 to 8%, and the Cr is eliminated. However, since a certain level of Al is included, build-up cannot be sufficiently prevented, and the oxidation resistance is poor due to there being no Cr. Therefore, sufficient effects cannot be exhibited.

Thus, with the conventional methods, it has been impossible to satisfy all of the above-described required characteristics. The present invention is directed to resolving such a problem. It is an object of the present invention to provide a long-life hearth roll having excellent build-up resistance against Mn-based substances, and which also has excellent thermal shock resistance and abrasion resistance.

### Means for Solving the Problems

To resolve the above-described problem, a thermal spray material that is thermally sprayed onto a surface of a hearth roll according to the present invention is characterized by comprising a heat resistant metal (including an alloy) that includes Al and can be used at 900° C. or more, and a double oxide of one kind or two kinds or more of a rare earth element (Sc, Y, lanthanum, and lanthanoids) and a transition metal excluding group 3A of the periodic table, Zr, Hf, and Fe, wherein when an Al content is A (moles), and a rare earth element (Sc, Y, lanthanum, and lanthanoids) content is B, the thermal spray material satisfies a condition of 0.3≦(A/B)≦4.0.

As the transition metal, any of Cr, Co, Ni, Cu, Nb, Mo, Ta, and W can be used. Examples of the heat resistant metal that can be used include MAl (wherein M comprises two or more kinds of a transition metal excluding group 3A of the periodic table, Ag, Cu, and Mn), and MAl(RE) (wherein M comprises two or more kinds of a transition metal excluding group 3A of the periodic table, Ag, Cu, and Mn, and (RE) is one kind of a rare earth element).

The above-described thermal spray material can be thermally sprayed onto a roll surface of a hearth roll. It is preferred that the thickness of the thermal spray coating on the roll surface be set to from 10 μm or more to 1,000 μm or less.

### Advantages of the Invention

According to the present invention, a hearth roll can be provided which has excellent build-up resistance against Mn-based substances, and which has excellent thermal shock resistance and abrasion resistance, yet has a long-life.

### BEST MODE FOR CARRYING OUT THE INVENTION

A hearth roll having excellent Mn build-up resistance, thermal shock resistance, and abrasion resistance, which is an embodiment of the present invention, will now be described in more detail.

### (Background Leading to the Creation of the Present Invention)

As a result of research performed by the present inventors, it was confirmed that an MnAl double oxide produced on the surface of the hearth roll is the main source of build-up. This MnAl double oxide is thought to be produced by Al present near the roll surface or Al₂O₃ produced by oxidation and MnO brought by the steel sheet undergoing reactions like those below. The thermal spray coating including Al is formed in the surface layer of the hearth roll. The steel sheet conveyed by the hearth roll contains Mn.
2Al+3MnO→Al₂O₃+3Mn (Al reduces MnO to produce Al₂O₃)
Mn+1/2O₂→MnO (reoxidation of Mn)
2Al+3/2O₂→Al₂O₃ (Al is oxidized to produce Al₂O₃)
Al₂O₃+MnO→MnAl₂O₄ (MnAl double oxide is produced by the produced Al₂O₃ and MnO)

In the conventional technologies, build-up resistance is maintained by decreasing the content of Al included in the hearth roll. However, if the Al content is low, the oxidation resistance of the coating is insufficient, while if the Al content is high, the build-up resistance is insufficient. Therefore, it has been impossible to determine an appropriate Al content.

Accordingly, rather than decreasing the Al content, the present inventors incorporated a double oxide of one kind or two kinds or more of a rare earth element (Sc, Y, lanthanum, and lanthanoids) and a transition metal excluding group 3A of the periodic table, Zr, Hf, and Fe. Consequently, of the Al in the heat resistant metal, the present inventors were successful in keeping the Al necessary to obtain oxidation resistance, while changing the rest into a double oxide which is difficult to react with MnO. As a result, Mn build-up resistance can be combined with thermal shock resistance, abrasion resistance, and oxidation resistance. Further, the Al content in the heat resistant metal does not affect the properties, and the need to limit the Al content is eliminated.

Specifically, although there are several side reactions, the Al can be turned into a double oxide that is difficult to react with MnO mainly by a reaction represented by the following equation.

Al+(RE)JxOy→(RE)AlOy+xJ
RE: Rare earth element
J: Transition metal excluding group 3A of the periodic table, Zr, Hf, and Fe
x, y: Coefficient determined by the valence of RE and J

The composition of the thermal spray material will now be described in more detail. A thermal spray material suitable for the hearth roll having excellent Mn build-up resistance, thermal shock resistance, and abrasion resistance according to the present embodiment is formed from a heat resistant metal (including an alloy) that includes Al and can be used at 900° C. or more, and a double oxide of a rare earth element (Sc, Y, lanthanum, and lanthanoids) and a transition metal excluding group 3A of the periodic table, Zr, Hf, and Fe.

The heat resistant metal is formed from MAl (wherein M comprises two or more kinds of transition metal element (Ti, V, Cr, Co, Ni, Nb, Mo, Tc, Ru, Rh, Pd, Ta, W, Re, Os, Ir, Pt, and Au), excluding group 3A of the periodic table, Ag, Cu, and Mn)) , or MAl (RE) (wherein M comprises two or more kinds of transition metal element (Ti, V, Cr, Co, Ni, Nb, Mo, Tc, Ru, Rh, Pd, Ta, W, Re, Os, Ir, Pt, and Au), excluding group 3A of the periodic table, Ag, Cu, and Mn, and (RE) is one kind of rare earth element, more specifically, is one kind from among Sc, Y, La, Ce, Pr, Nd, Pm, Sm, Eu, Gd, Tb, Dy, Ho, Er, Tm, Yb, and Lu)).

Preferably, FeCrAlY, NiCrAlY, CoCrAlY, CoNiCrAlY, FeCrAl, NiCrAl, CoCrAl, or CoNiCrAl is used as the heat resistant metal.

It is preferred to use Cr, Co, Ni, Cu, Nb, Mo, Ta, and W as the transition metal included in the double oxide. Furthermore, to improve heat resistance and oxidation resistance, a non-metal, such as C and Si, may also be included in the heat resistant metal.

When the content of the Al included in the thermal spray material(heat resistant metal) is A (moles), and the content of the rare earth element (Sc, Y, lanthanum, and lanthanoids) included in the thermal spray material is B (moles), the composition ratio must be set so that (A/B) is 0.3 to 4.0. If (A/B) is less than 0.3, there is too much of the rare earth element (the added double oxide is too much), so that the thermal shock resistance value of the thermal spray coating decreases. If (A/B) is more than 4.0, there is too much Al, so that build-up resistance deteriorates. Preferably, the composition ratio of the Al and the rare earth element (Sc, Y, lanthanum, and lanthanoids) is set so that (A/B) is 0.5 to 2.0.

The double oxide of the present embodiment can be produced by mixing the respective oxides of an oxidized rare earth element (Sc, Y, lanthanum, and lanthanoids) and an oxidized transition metal element excluding group 3A of the periodic table, Zr, Hf, and Fe, and then calcining the resultant mixture. Further, to promote formation of the Al-containing double oxide, the double oxide may be obtained by adding an organic binder to a fine heat resistant metal powder that includes Al and can be used at 900° C. or more, and a fine double oxide powder of a rare earth element (Sc, Y, lanthanum, and lanthanoids) and a transition metal excluding group 3A of the periodic table, Zr, Hf, and Fe, and then granulating the resultant mixture. Examples of granulating methods that can be used include Common spray granulation methods, a fluidized bed granulation method, mechanical alloying and the like.

As a result of the heating during the thermal spraying, the above-described reaction occurs, which enables a double oxide of a rare earth metal and Al to be produced. However, it is more preferred to promote production of the double oxide of a rare earth metal and Al at the thermal spray material stage by removing a binder and performing calcining.

The thermal spraying method of the thermal spray material in the present embodiment is not especially limited. Examples of methods that can be used include flame thermal spraying, plasma thermal spraying, HVOF thermal spraying, and detonation thermal spraying. Among these methods, HVOF thermal spraying and detonation thermal spraying are preferred, because of their low thermal effect and because a dense coating can be formed.

The thickness of the thermal spray coating is preferably 10 μm or more to 1,000 μm or less. If the thickness is less than 10 μm, the effects from the coating cannot be exhibited, while if the thickness is more than 1,000 μm, residual stress increases, so that the coating may peel.

To improve the thermal shock resistance even further, a thermal spray coating, such as a M′CrAlY (wherein M′ is one kind or two or more kinds of metal element selected from Fe, Ni, and Co), an NiCr alloy, a hastelloy, an inconel alloy, Ni—Al, or Mo and the like maybe provided between the thermal spray coating and the roll substrate. In this case, the thermal spray coating corresponds to the roll surface described in claim 4.

As described above, a hearth roll can be provided which has excellent build-up resistance against Mn, and which has excellent thermal shock resistance and abrasion resistance, yet has along-life, by forming a thermal spray coating on the surface of the hearth roll substrate with the thermal spray material according to the embodiment of the present invention.

### EXAMPLES

Next, the hearth roll, and the thermal spray material therefor, according to the present invention having excellent Mn build-up resistance, thermal shock resistance, and abrasion resistance, will be described in more detail using the following examples. However, the hearth roll and thermal spray material therefor according to the present invention having excellent Mn build-up resistance, thermal shock resistance, and abrasion resistance, are not limited to the following examples.

In order to confirm the operation and effects of the present invention, test pieces (hereinafter, “TP”) were manufactured from SUS304 (for Mn build-up resistance: 15×15×10 mm, for thermal shock resistance: 30×50×5 mm, and abrasion resistance 50×50×10 mm). A coating was laminated onto the surface of the TPs by a thermal spraying method (high-velocity gas thermal spraying), and the following tests were carried out.

### With Regard to Mn Build-Up Resistance

FIG. 1 is a schematic view of a test machine for evaluating the Mn build-up resistance of a TP. Thermal spray coatings 11A and 12A having the two thermal spray TPs 11 and 12 are arranged facing each other. A build-up raw material MnO powder is sandwiched between the thermal spray coatings 11A and 12A, and then a load is applied from above the TP11. The resultant structure is arranged in an electric furnace, and left for about 25 hours at a constant temperature of 950° C. in an N₂-5% H₂ reducing atmosphere. The test conditions are shown in Table 1.

TABLE 1

| Item | Condition |
|---|---|
| Atmosphere | N₂ - 5% H₂ |
| Temperature, Time | 950° C. 25 Hr |
| Load | 0.4 g/mm² |

After the test, EPMA (electron probe micro-analyzer) surface analysis was carried out across a TP cross-section. In the surface analysis results, a total of the adhered thickness on the Mn thermal spray coating and the depth of penetration into the thermal spray coating of 30 μm or less was determined as good (circle), 20 μm or less as excellent (double circle), and more than 30 μm as no good (cross).

### Concerning Abrasion Resistance

FIG. 2 is a schematic view of a test machine for evaluating the abrasion resistance of a TP. The following test was carried out for evaluating abrasion resistance. As illustrated in FIG. 2, a “Suga Abrasion Tester” was used in the experiment. Emery paper 22 is wound around the outer surface of a rotating roller 21. A thermal spray coating 31A of a TP31 is brought into contact with the emery paper 22. The TP31 can reciprocally move in a horizontal direction. The test conditions are shown in Table 2.

TABLE 2

| Item | Condition |
|---|---|
| Emery Paper | SiC, #320 |
| Load | 3 kg |

With the rotating roller 21 in a stopped state, the TP31 is made to move back and forth in a horizontal direction, so that the thermal spray coating 31A slides against the emery paper 22. Next, the rotating roller 21 is made to slightly rotate, so that an unused surface of the emery paper 22 abuts the thermal spray coating 31A. The abrasion resistance is evaluated on the basis of the number of reciprocations of the TP required for 1 mg of the thermal spray coating to be abraded (double stroke (DS)/mg). TPs having a number of reciprocations of less than 20 DS/mg were evaluated as no good (cross), while TPs having a number of reciprocations of 20 DS/mg or more were evaluated as good (circle).

### Thermal Shock Resistance

The following test was carried out to evaluate thermal shock resistance. A TP (50×50×10 mm) laminated with a thermal spray coating was heated in an electric furnace, cooled with water, and then evaluated for the presence of peeling of the thermal spray coating. TPs that had no thermal spray coating peeling after repeating this test thirty times were evaluated as excellent (double circle), TPs that had no thermal spray coating peeling after repeating this test twenty times were evaluated as good (circle), and TPs in which peeling occurred after less than twenty test repetitions were evaluated as no good (cross). The test conditions are shown in Table 3.

TABLE 3

| Item | Condition |
|---|---|
| Atmonphere | 1000° C. |
| Temperature | |
| Heating Time | 30 min |

Table 4A shows the compositions of Invention Examples 1 to 43. Table 4B shows the compositions of Comparative Examples 1 to 12. Table 5 shows the test results and evaluation of Mn build-up resistance, thermal shock resistance, and abrasion resistance, wherein Table 5A is for Invention Examples 1 to 43, and Table 5B is for Comparative Examples 1 to 12. If all of the evaluation items are good (circle) or better, the overall evaluation was evaluated as good (circle). If all of the evaluation items are good (circle) or better, and two or more of the evaluation items are excellent (double circle), the overall evaluation was evaluated as excellent (double circle). If even one of the evaluation items is no good (cross), the overall evaluation was evaluated as no good (cross).

TABLE 4A

| | | | Thermal Spray Coating Composition | | |
|---|---|---|---|---|---|
| | | | | | Al Content A |
| | | | | | (moles)/ |
| | | | Matrix Metal | | Rare Earth |
| | | | (heat | Double Oxide | Element |
| | | | resistant | Including Rare | Content B |
| | | Matrix | metal) | Earth Element | (moles) |
| Invention | 1 | SUS304 | CoCrAlY | YCrO₃ | 0.3 |
| Example | 2 | | CoCrAlY | YCrO₃ | 0.5 |
| | 3 | | CoCrAlY | YCrO₃ | 1 |
| | 4 | | CoCrAlY | YCrO₃ | 2 |
| | 5 | | CoCrAlY | YCrO₃ | 3 |
| | 6 | | CoCrAlY | YCrO₃ | 4 |
| | 7 | | CoNICrAlY | YCrO₃ | 0.3 |
| | 8 | | CoNICrAlY | YCrO₃ | 0.5 |
| | 9 | | CoNICrAlY | YCrO₃ | 2 |
| | 10 | | CoNICrAlY | YCrO₃ | 3 |
| | 11 | | NICrAl | YCrO₃ | 0.3 |
| | 12 | | NICrAl | YCrO₃ | 0.5 |
| | 13 | | NICrAl | YCrO₃ | 2 |
| | 14 | | NICrAl | YCrO₃ | 3 |
| | 15 | | CoCrAlY | LaCoO₃ | 0.3 |
| | 16 | | CoCrAlY | LaCoO₃ | 0.5 |
| | 17 | | CoCrAlY | LaCoO₃ | 2 |
| | 18 | | CoCrAlY | LaCoO₃ | 3 |
| | 19 | | CoCrAlY | GdCrO₃ | 0.3 |
| | 20 | | CoCrAlY | GdCrO₃ | 0.5 |
| | 21 | | CoCrAlY | GdCrO₃ | 2 |
| | 22 | | CoCrAlY | GdCrO₃ | 3 |
| | 23 | | CoCrAlY | La₂NIO₄ | 0.3 |
| | 24 | | CoCrAlY | La₂NIO₄ | 0.5 |
| | 25 | | CoCrAlY | La₂NIO₄ | 2 |
| | 26 | | CoCrAlY | La₂NIO₄ | 3 |
| | 27 | | CoCrAlY | Sc_{0.5}Y_{0.5}CrO₃ | 1 |
| | 28 | | FeCrAlY | LaCoO₃ | 0.3 |
| | 29 | | FeCrAlY | LaCoO₃ | 0.5 |
| | 30 | | FeCrAlY | LaCoO₃ | 2 |
| | 31 | | FeCrAlY | LaCoO₃ | 3 |
| | 32 | | FeCrAl | LaCoO₃ | 0.3 |
| | 33 | | FeCrAl | LaCoO₃ | 0.5 |
| | 34 | | FeCrAl | LaCoO₃ | 2 |
| | 35 | | FeCrAl | LaCoO₃ | 3 |
| | 36 | | CoCrAl | LaCoO₃ | 0.3 |
| | 37 | | CoCrAl | LaCoO₃ | 0.5 |
| | 38 | | CoCrAl | LaCoO₃ | 2 |
| | 39 | | CoCrAl | LaCoO₃ | 3 |
| | 40 | | CoNICrAl | LaCoO₃ | 0.3 |
| | 41 | | CoNICrAl | LaCoO₃ | 0.5 |
| | 42 | | CoNICrAl | LaCoO₃ | 2 |
| | 43 | | CoNICrAl | LaCoO₃ | 3 |

TABLE 4B

| | | | Thermal Spray Coating Composition | | |
|---|---|---|---|---|---|
| | | | | | Al Content |
| | | | Matrix | | A (moles)/ |
| | | | Metal | | Rare Earth |
| | | | (heat | Double Oxide | Element |
| | | | resistant | Including Rare | Content B |
| | | Matrix | metal) | Earth Element | (moles) |
| Comparative | 1 | SUS304 | CoCrAlY | YCrO₃ | 0.2 |
| Examples | 2 | | CoCrAlY | YCrO₃ | 4.5 |
| | 3 | | CoNICrAlY | YCrO₃ | 0.2 |
| | 4 | | CoNICrAlY | YCrO₃ | 4.5 |
| | 5 | | NICrAl | YCrO₃ | 0.2 |
| | 6 | | NICrAl | YCrO₃ | 4.5 |
| | 7 | | CoCrAlY | LaCoO₃ | 0.2 |
| | 8 | | CoCrAlY | LaCoO₃ | 4.5 |
| | 9 | | CoCrAlY | GdCrO₃ | 0.2 |
| | 10 | | CoCrAlY | GdCrO₃ | 4.5 |
| | 11 | | CoCrAlY | La₂NIO₄ | 0.2 |
| | 12 | | CoCrAlY | La₂NIO₄ | 4.5 |

TABLE 5A

| | | | Mn Build-Up | | | | | | |
|---|---|---|---|---|---|---|---|---|---|
| | | | Resistance Test | | | | | | |
| | | | Mn Adhered | | Abrasion | | | | |
| | | | Thickness + | | Resistance Test | | | | |
| | | | Mn Depth of | | Test | | Thermal Shock | | |
| | | | Penetration | | Results | | Resistance Test | | Overall |
| | | Matrix | μm | Evaluation | DS/mg | Evaluation | Test Results | Evaluation | Evaluation |
| Invention | 1 | SUS304 | 5 | ⊚ | 30 | ◯ | Pass test 20 times | ◯ | ◯ |
| Example | 2 | | 9 | ⊚ | 30 | ◯ | Pass test 30 times | ⊚ | ⊚ |
| | 3 | | 13 | ⊚ | 29 | ◯ | Pass test 30 times | ⊚ | ⊚ |
| | 4 | | 17 | ⊚ | 27 | ◯ | Pass test 30 times | ⊚ | ⊚ |
| | 5 | | 24 | ◯ | 23 | ◯ | Pass test 30 times | ⊚ | ◯ |
| | 6 | | 28 | ◯ | 22 | ◯ | Pass test 20 times | ⊚ | ◯ |
| | 7 | | 5 | ⊚ | 32 | ◯ | Pass test 30 times | ◯ | ◯ |
| | 8 | | 10 | ⊚ | 30 | ◯ | Pass test 30 times | ⊚ | ⊚ |
| | 9 | | 17 | ⊚ | 27 | ◯ | Pass test 30 times | ⊚ | ⊚ |
| | 10 | | 25 | ◯ | 24 | ◯ | Pass test 30 times | ⊚ | ◯ |
| | 11 | | 9 | ⊚ | 32 | ◯ | Pass test 20 times | ◯ | ◯ |
| | 12 | | 12 | ⊚ | 30 | ◯ | Pass test 30 times | ⊚ | ⊚ |
| | 13 | | 18 | ⊚ | 27 | ◯ | Pass test 30 times | ⊚ | ⊚ |
| | 14 | | 26 | ◯ | 23 | ◯ | Pass test 30 times | ⊚ | ◯ |
| | 15 | | 6 | ⊚ | 32 | ◯ | Pass test 20 times | ◯ | ◯ |
| | 16 | | 8 | ⊚ | 31 | ◯ | Pass test 30 times | ⊚ | ⊚ |
| | 17 | | 17 | ⊚ | 29 | ◯ | Pass test 30 times | ⊚ | ⊚ |
| | 18 | | 28 | ◯ | 25 | ◯ | Pass test 30 times | ⊚ | ◯ |
| | 19 | | 8 | ⊚ | 30 | ◯ | Pass test 20 times | ◯ | ◯ |
| | 20 | | 11 | ⊚ | 30 | ◯ | Pass test 30 times | ⊚ | ⊚ |
| | 21 | | 18 | ⊚ | 29 | ◯ | Pass test 30 times | ⊚ | ⊚ |
| | 22 | | 24 | ◯ | 27 | ◯ | Pass test 30 times | ⊚ | ◯ |
| | 23 | | 10 | ⊚ | 31 | ◯ | Pass test 20 times | ◯ | ◯ |
| | 24 | | 12 | ⊚ | 30 | ◯ | Pass test 30 times | ⊚ | ⊚ |
| | 25 | | 20 | ⊚ | 26 | ◯ | Pass test 30 times | ⊚ | ⊚ |
| | 26 | | 27 | ◯ | 22 | ◯ | Pass test 30 times | ⊚ | ◯ |
| | 27 | | 12 | ⊚ | 25 | ◯ | Pass test 30 times | ⊚ | ⊚ |
| | 28 | | 9 | ⊚ | 34 | ◯ | Pass test 20 times | ◯ | ◯ |
| | 29 | | 12 | ⊚ | 30 | ◯ | Pass test 30 times | ⊚ | ⊚ |
| | 30 | | 22 | ⊚ | 24 | ◯ | Pass test 30 times | ⊚ | ⊚ |
| | 31 | | 27 | ◯ | 21 | ◯ | Pass test 30 times | ⊚ | ◯ |
| | 32 | | 11 | ⊚ | 33 | ◯ | Pass test 20 times | ◯ | ◯ |
| | 33 | | 15 | ⊚ | 30 | ◯ | Pass test 30 times | ⊚ | ⊚ |
| | 34 | | 19 | ⊚ | 27 | ◯ | Pass test 30 times | ⊚ | ⊚ |
| | 35 | | 26 | ◯ | 24 | ◯ | Pass test 30 times | ⊚ | ◯ |
| | 36 | | 7 | ⊚ | 31 | ◯ | Pass test 20 times | ◯ | ◯ |
| | 37 | | 12 | ⊚ | 28 | ◯ | Pass test 30 times | ⊚ | ⊚ |
| | 38 | | 18 | ⊚ | 25 | ◯ | Pass test 30 times | ⊚ | ⊚ |
| | 39 | | 23 | ◯ | 22 | ◯ | Pass test 30 times | ⊚ | ◯ |
| | 40 | | 8 | ⊚ | 34 | ◯ | Pass test 20 times | ◯ | ◯ |
| | 41 | | 10 | ⊚ | 31 | ◯ | Pass test 30 times | ⊚ | ⊚ |
| | 42 | | 19 | ⊚ | 27 | ◯ | Pass test 30 times | ⊚ | ⊚ |
| | 43 | | 25 | ◯ | 23 | ◯ | Pass test 30 times | ⊚ | ◯ |

TABLE 5B

| | | | Mn Build-Up | | | | | | |
|---|---|---|---|---|---|---|---|---|---|
| | | | Resistance Test | | | | | | |
| | | | Mn Adhered | | Abrasion | | | | |
| | | | Thickness + | | Resistance Test | | | | |
| | | | Mn Depth of | | Test | | Thermal Shock | | |
| | | | Penetration | | Results | | Resistance Test | | Overall |
| | | Matrix | μm | Evaluation | DS/mg | Evaluation | Test Results | Evaluation | evaluation |
| Comparative | 1 | SUS304 | 5 | ⊚ | 32 | ◯ | Peeling in 19th round | X | X |
| Example | 2 | | 31 | X | 22 | ◯ | Pass test 30 times | ⊚ | X |
| | 3 | | 7 | ⊚ | 33 | ◯ | Peeling in 18th round | X | X |
| | 4 | | 33 | X | 21 | ◯ | Pass test 30 times | ⊚ | X |
| | 5 | | 9 | ⊚ | 30 | ◯ | Peeling in 18th round | X | X |
| | 6 | | 31 | X | 23 | ◯ | Pass test 30 times | ⊚ | X |
| | 7 | | 6 | ⊚ | 32 | ◯ | Peeling in 17th round | X | X |
| | 8 | | 32 | X | 23 | ◯ | Pass test 30 times | ⊚ | X |
| | 9 | | 10 | ⊚ | 33 | ◯ | Peeling in 18th round | X | X |
| | 10 | | 31 | X | 25 | ◯ | Pass test 30 times | ⊚ | X |
| | 11 | | 9 | ⊚ | 29 | ◯ | Peeling in 18th round | X | X |
| | 12 | | 32 | X | 23 | ◯ | Pass test 30 times | ⊚ | X |

Invention Examples 1 to 43 had a thermal spray coating formed on the TP surface by a thermal spraying method, with a thickness set in the range of 10 to 1,000 μm, and a value of Al content (A moles) included in the heat resistant metal/total rare earth element content (B moles) in the coating set between 0.3 and 4.0.

As illustrated in Table 5, Invention Examples 1 to 43 exhibited good results for the Mn build-up resistance test, the thermal shock resistance test, and the abrasion resistance test. Among them, the thermal spray coatings having a value of Al content (A moles) included in the heat resistant metal/total rare earth element content (B moles) in the coating of between 0.5 and 2.0 received an excellent (double circle) evaluation in the Mn build-up resistance test and the thermal shock resistance test, and were thus given an overall evaluation of excellent (double circle).

On the other hand, Comparative Examples 1 and 2 differ from Invention Examples 1 to 6 in having a value of Al content (A moles) included in the heat resistant metal/total rare earth element content (B moles) in the coating that is not in the range 0.3 to 4.0. As illustrated in Table 5, Comparative Example 1 received a no-good evaluation for the thermal shock resistance test, and Comparative Example 2 received a no good for the total of the Mn adhered thickness and the Mn depth of penetration in the Mn build-up resistance test. Thus, Comparative Examples 1 and 2 received an overall evaluation of no good (cross).

Comparative Examples 3 and 4 differ from Invention Examples 7 to 10 in having a value of Al content (A moles) included in the heat resistant metal/total rare earth element content (B moles) in the coating that is not in the range 0.3 to 4.0. As illustrated in Table 5, Comparative Example 3 received a no-good evaluation for the thermal shock resistance test, and Comparative Example 4 received a no good for the total of the Mn adhered thickness and the Mn depth of penetration in the Mn build-up resistance test. Thus, Comparative Examples 3 and 4 received an overall evaluation of no good (cross).

Comparative Examples 5 and 6 differ from Invention Examples 11 to 14 in having a value of Al content (A moles) included in the heat resistant metal/total rare earth element content (B moles) in the coating that is not in the range 0.3 to 4.0. As illustrated in Table 5, Comparative Example 5 received a no-good evaluation for the thermal shock resistance test, and Comparative Example 6 received a no good for the total of the Mn adhered thickness and the Mn depth of penetration in the Mn build-up resistance test. Thus, Comparative Examples 5 and 6 received an overall evaluation of no good (cross).

Comparative Examples 7 and 8 differ from Invention Examples 15 to 18 in having a value of Al content (A moles) included in the heat resistant metal/total rare earth element content (B moles) in the coating that is not in the range 0.3 to 4.0. As illustrated in Table 5, Comparative Example 7 received a no-good evaluation for the thermal shock resistance test, and Comparative Example 8 received a no good for the total of the Mn adhered thickness and the Mn depth of penetration in the Mn build-up resistance test. Thus, Comparative Examples 7 and 8 received an overall evaluation of no good (cross).

Comparative Examples 9 and 10 differ from Invention Examples 19 to 22 in having a value of Al content (A moles) included in the heat resistant metal/total rare earth element content (B moles) in the coating that is not in the range 0.3 to 4.0. As illustrated in Table 5, Comparative Example 9 received a no-good evaluation for the thermal shock resistance test, and Comparative Example 10 received a no good for the total of the Mn adhered thickness and the Mn depth of penetration in the Mn build-up resistance test. Thus, Comparative Examples 9 and 10 received an overall evaluation of no good (cross).

Comparative Examples 11 and 12 differ from Invention Examples 23 to 26 in having a value of Al content (A moles) included in the heat resistant metal/total rare earth element content (B moles) in the coating that is not in the range 0.3 to 4.0. As illustrated in Table 5, Comparative Example 11 received a no-good evaluation for the thermal shock resistance test, and Comparative Example 12 received a no good for the total of the Mn adhered thickness and the Mn depth of penetration in the Mn build-up resistance test. Thus, Comparative Examples 11 and 12 received an overall evaluation of no good (cross).

### BRIEF DESCRIPTION OF THE DRAWINGS

FIG. 1 is a schematic view of a test machine for evaluating Mn build-up resistance.

FIG. 2 is a schematic view of a test machine for evaluating abrasion resistance.

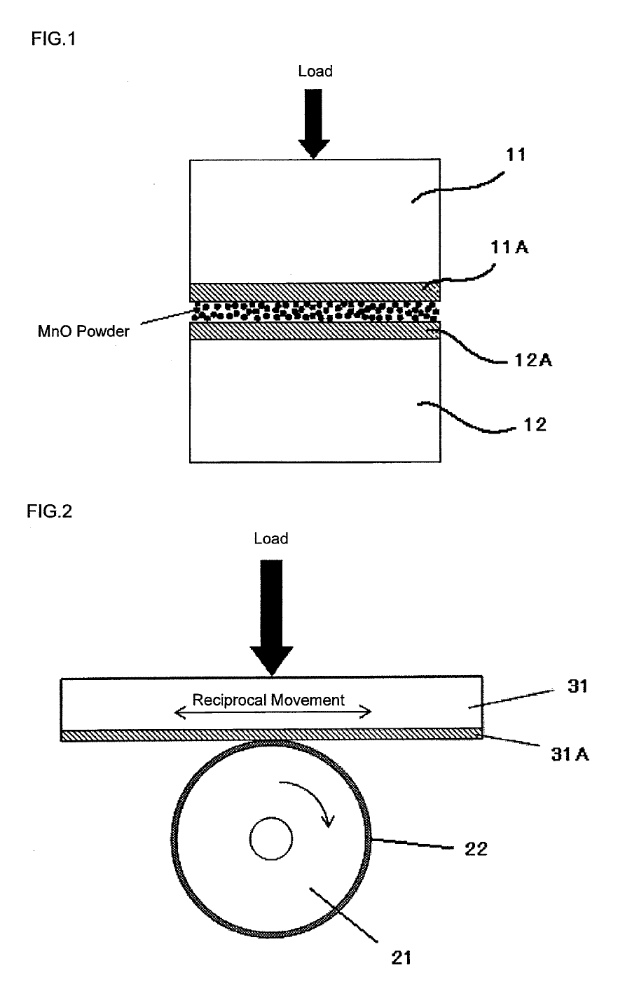

### DESCRIPTION OF REFERENCE NUMERALS

11, 12, 31 TP
11A, 12A, 31A Thermal spray coating
21 Rotating roller
22 Emery paper

1-3. (canceled)

4. A hearth roll comprising a roll surface
wherein a thermal spray is present on the roll surface,
wherein the thermal spray comprises:
a heat resistant metal comprising an alloy that includes Al and can be used at 900° C. or more
a double oxide of a rare earth element and a transition metal excluding group 3A of the periodic table, Zr, Hf, and Fe; and
a double oxide of the rare earth element and Al,
wherein the thermal spray material satisfies a condition of 0.3≦A/B≦4.0,
wherein A is the molar content of the Al, and
wherein B is the molar content of the rare earth element, and
wherein the rare earth element is selected from the group consisting of Sc, Y, lanthanum, lanthanoids, and mixtures thereof

5. The hearth roll according to claim 4, wherein the thermal spray on the roll surface has a thickness of from 10 μm or more to 1,000 μm or less.

6. The hearth roll according to claim 4, wherein the transition metal is any of Cr, Co, Ni, Cu, Nb, Mo, Ta, and W.

7. The hearth roll according to claim 4,
wherein:
the heat resistant metal is MAl or MAlRE;
M comprises two or more kinds of a transition metal excluding group 3A of the periodic table, Ag, Cu, and Mn; and
RE is one kind of a rare earth element.
